(19) United States
(12) Patent Application Publication
(10) Pub. No.: US 2007/0295854 A1
(43) Pub. Date: Dec. 27, 2007

(54) Tape Dispenser

(76) Inventor: Sarah Thorp, Felmingham (GB)

Correspondence Address: BRUCE E. LILLING;LILLING & LILLING PLLC, P.O. BOX 560, GOLDEN BRIDGE, NY, 10526, US

(21) Appl. No.: 11/571,750

(22) PCT Filed: Jul. 6, 2005
(86) PCT No.: PCT/GB05/02649

§ 371 Date: Feb. 13, 2007

(30) Foreign Application Priority Data
Jul. 8, 2004 (GB) 0415294.8

(51) Int. Cl. B65D 85/02; B65D 85/67; B44C 7/00

(52) U.S. Cl. 242/588.3; 242/588.6; 156/577

(57) ABSTRACT

A tape dispenser in which means for securing the dispenser to a tape roll comprises an arc of sufficient length to fit within the hollow core of the roll and follow a section of the hollow core's circumference to support the dispenser on the roll whilst allowing the roll to rotate relative to the dispenser as the tape unrolls in use; means for holding the unrolled portion of the tape away from the roll; and means for cutting the tape from the unrolled portion; characterised by the features that the means for holding the unrolled portion of tape away from the roll consists of respective first and second spars on the dispenser spanning or substantially spanning the tape width and the space between the first and second spars is sufficient and/or sufficiently unimpeded to allow a user of the dispenser to insert a finger and lift the tape.

### FIELD OF THE INVENTION

This invention relates to tape dispensers in particular, but not exclusively, to tape dispensers which dispense adhesive material pre-mounted onto a roll.

### BACKGROUND TO THE INVENTION

The prior art known to the applicant is US2003/0141338, GB2306372, GB1143188, GB738142, U.S. Pat. No. 2,609,877, U.S. Pat. No. 3,134,526, U.S. Pat. No. 4,711,384, GB771834, U.S. Pat. No. 5,071,051, U.S. Pat. No. 2,262,260, GB2143505, GB2106861, GB2095154, GB2201946, GB1278437, U.S. Pat. No. 4,405,068, U.S. Pat. No. 2,670,042, U.S. Pat. No. 2,560,394, U.S. Pat. No. 2,611,432, BE498366, U.S. Pat. No. 4,858,807, DE958816, DE884921, DE1924979, DE2400178, EP0236276, GB736499, U.S. Pat. No. 5,363,997, U.S. Pat. No. 2,626,666, U.S. Pat. No. 3,970,230, U.S. Pat. No. 2,734,576, U.S. Pat. No. 765,497, U.S. Pat. No. 2,734,575, EP0103435, GB1143594, GB1221532, U.S. Pat. No. 2,472,761, GB1269980, GB3922155, U.S. Pat. No. 5,634,580, EP0227285, GB791642, U.S. Pat. No. 2,528,958, GB2265354 and U.S. Pat. No. 4,957,234.

The closest prior art known to the applicant and therefore the starting point of the present invention is US2003/0141338 (ORTIN et al) which discloses a tape dispenser secured to a tubular core piece on a roll by a bearing and guiding bracket pivotally mounted to arms located either side of the tape to be dispensed, the two arms are kept in a rigid and fixed relationship by a transverse rib therebetween upon which the blade is mounted, each arm having holding wings projecting towards the opposing arm and upon which the free end of the tape rests after the cut has been made by the cutting blade.

The invention shown in US2003/0141338 (ORTIN et al) holds a portion of the unrolled tape away from the main roll at the front of the device where the holding wings are located. The holding wings come into contact with a portion of the tape set back from the front of the tape. For successive cuts, the user grabs the overhanging end of the tape depending from the holding wings and unwinds the required amount of tape, once at this position, the tape is lifted in an upwardly and backwardly direction to engage the non-adhesive side of the tape with the blade and the cut is made when a downwards pressure is exerted on the free end of the tape. If after cutting the free end of the tape is maintained against the blade without falling back on to the holding wings, then the configuration is such that, to perform a successive cut, a user is unable to insert a finger between the tape, the blade and/or the inner walls of the arms in order to lift the tape. In such a situation, the tape would be released by holding the roll whilst pulling or pushing the arms forward then grasping the free end of the tape as it is released from the blade. The tape cutting means are teeth having a single profile. The blade portion projects from the plane of the transverse rib and is the highest point of the tape dispenser. No guard is provided in the region at the side of the blade. The bearing and guiding bracket has three sections: a first straight section upon which the arms are pivotally mounted, followed by a curved section being so shaped as to follow the curve of the roll's core and then a second straight section upon which at least one side guard/guide is provided.

### SUMMARY OF THE INVENTION

According to a first broad independent aspect of the invention, there is provided a tape dispenser in which means for securing the dispenser to a tape roll comprises an arc of sufficient length to fit within the hollow core of the roll and follow a section of the hollow core's circumference to support the dispenser on the roll whilst allowing the roll to rotate relative to the dispenser as the tape unrolls in use; means for holding the unrolled portions of the tape away from the roll; and means for cutting the tape from the unrolled portion; characterised by the features that the means for holding the unrolled portion of tape away from the roll consists of respective first and second spars on the dispenser spanning or substantially spanning the tape width and the space between the first and second spars is sufficient and/or sufficiently unimpeded to allow a user of the dispenser to insert a finger and lift the tape.

The configuration of the means for holding the unrolled portion of tape away from the roll is advantageous because it minimises any likelihood of the unrolled tape portion inadvertently returning onto the roll. It also does away with the prior art requirement of necessarily using the cutting surface as a surface against which the tape automatically rests.

The advantage associated with the space between the first and second spars is that this configuration allows the operator to easily access the tape between successive cuts without having to start peeling back with great difficulty a stuck-on portion of a tape. This feature also offers both a time saving attribute as well as improved efficiency as it reduces the amount of waste material when using the device - without this ability to grasp the edge of the tape, significant portions of the tape might be rendered un-adhesive and useless when the free end has been lifted.

According to a subsidiary aspect of the present invention there is provided a tape dispenser wherein the tape-cutting means includes teeth of more than one tooth profile.

This is particularly advantageous because it allows the overall profile of the tape cutting means to be a more efficient cutting tool. The tape cutting means may also ensure that a variety of different materials may be used with the device and the profile may assist the retention of the material being cut.

According to a farther subsidiary aspect of the present invention there is provided a tape dispenser wherein the tape-cutting means is guarded at one or each tape-edge region by means tending to prevent the tape being pulled off its centre line as the tape is severed.

Such a configuration advantageously prevents the tape from tending to travel sideways when being pulled out of its reel. This feature also reduces the likelihood of injury to an operator.

According to a subsidiary aspect of the present invention there is provided a tape dispenser wherein at least one of the first and second spars can be rotated by the tape as the tape is unrolled.

This is particularly advantageous when the adhesive side comes into contact with the spars, instead of hindering the dispensing of the taped material, the tape can more easily be drawn past the spars.

According to a further subsidiary aspect of the present invention there is provided a tape dispenser further comprising a third spar, spanning or substantially spanning the tape width, in use, above the unrolled portion of the tape and so positioned that a user can rest a portion of their hand against it without hindering the tape movement.

Such a configuration allows a safe location for an operator to apply pressure say by using his/her thumb.

According to a still further aspect of the present invention there is provided a tape dispenser wherein a portion of the core supporting arc adjacent the main body of the dispenser is curved in the opposite sense to the curve of the rest of the arc.

Advantageously, this allows the operator to intuitively grasp the dispenser.

According to a second broad independent aspect of the invention, there is provided a tape dispenser in which means for securing the dispenser to a tape roll comprises an arc of sufficient length to fit within the hollow core of the roll and follow a section of the hollow core's circumference to support the dispenser on the roll whilst allowing the roll to rotate relative to the dispenser as the tape unrolls in use; means for holding the unrolled portion of the tape away from the roll; and means for cutting the tape from the unrolled portion; characterised by the features that the means for holding the unrolled portion of tape away from the roll consists of respective first and second spars on the dispenser spanning or substantially spanning the tape width; and that the tape-cutting means includes teeth of more than one tooth profile.

Such a configuration is advantageous because it minimises any likelihood of the unrolled tape portion inadvertently returning onto the roll. It also does away with the prior art requirement of necessarily using the cutting surface as a surface against which the tape automatically rests.

It is particularly advantageous because it allows the overall profile of the tape cutting means to be a more efficient cutting tool. The tape cutting means may also ensure that a variety of different materials may be used with the device and the profile may assist the retention of the material being cut.

According to a third broad independent-aspect of the invention, there is provided a tape dispenser in which means for securing the dispenser to a tape roll comprises an arc of sufficient length to fit within the hollow core of the roll and follow a section of the hollow core's circumference to support the dispenser on the roll whilst allowing the roll to rotate relative to the dispenser as the tape unrolls in use; means for holding the unrolled portion of the tape away from the roll; and means for cutting the tape from the unrolled portion; characterised by the features that the means for holding the unrolled portion of tape away from the roll consists of respective first and second spars on the dispenser spanning or substantially spanning the tape width and that the tape-cutting means is guarded at one or each tape-edge region by means tending to prevent the tape being pulled off its centre line as the tape is severed.

Such a configuration is advantageous because it minimises any likelihood of the unrolled tape portion inadvertently returning onto the roll. It also does away with the prior art requirement of necessarily using the cutting surface as a surface against which the tape automatically rests. Also it is particularly advantageous as it prevents the tape from tending to travel sideways when being pulled out of its reel. This feature also reduces the likelihood of injury to an operator.

According to a fourth broad independent aspect of the invention, there is provided a tape dispenser in which means for securing the dispenser to a tape roll comprises an arc of sufficient length to fit within the hollow core of the roll and follow a section of the hollow core's circumference to support the dispenser on the roll whilst allowing the roll to rotate relative to the dispenser as the tape unrolls in use; means for holding the unrolled portion of the tape away from the roll; and means for cutting the tape from the unrolled portion; characterised by the features that the means for holding the unrolled portion of tape away from the roll consists of respective first and second spars on the dispenser spanning or substantially spanning the tape width and that at least one of the first and second spars can be rotated by the tape as the tape is unrolled.

Such a configuration is advantageous because it minimises any likelihood of the unrolled tape portion inadvertently returning onto the roll. It also does away with the prior art requirement of necessarily using the cutting surface against which the tape automatically rests. And it is particularly advantageous when the adhesive side comes into contact with the spars, instead of hindering the dispensing of the taped material, the tape can more easily be drawn past the spars.

According to a fifth broad independent aspect of the invention, there is provided a tape dispenser in which means for securing the dispenser to a tape roll comprises an arc of sufficient length to fit within the hollow core of the roll and follow a section of the hollow core's circumference to support the dispenser on the roll whilst allowing the roll to rotate relative to the dispenser as the tape unrolls in use; means for holding the unrolled portion of the tape away from the roll; and means for cutting the tape from the unrolled portion; characterised by the features that the means for holding the unrolled portion of tape away from the roll consists of respective first and second spars on the dispenser spanning or substantially spanning the tape width and that there is a third spar, spanning or substantially spanning the tape width, in use, above the unrolled portion of the tape and so positioned that a user can rest a portion of their hand against it without hindering the tape movement.

Such a configuration is advantageous because it minimises any likelihood of the unrolled tape portion inadvertently returning onto the roll. It also does away with the prior art requirement of necessarily using the cutting surface as a surface against which the tape automatically rests. And it allows a safe location for an operator to apply pressure say by using his/her thumb.

According to a sixth and final broad independent aspect, the invention provides a tape dispenser in which means for securing the dispenser to a tape roll comprises an arc of sufficient length to fit within the hollow core of the roll and follow a section of the hollow core's circumference to support the dispenser on the roll whilst allowing the roll to rotate relative to the dispenser as the tape unrolls in use; means for holding the unrolled portion of the tape away from the roll; and means for cutting the tape from the unrolled portion; characterised by the features that the means for holding the unrolled portion of tape away from the roll consists of respective first and second spars on the dispenser spanning or substantially spanning the tape width and that a portion of the core-supporting arc adjacent the main body of the dispenser is curved in the opposite sense to the curve of the rest of the arc.

Such a configuration is advantageous because it minimises any likelihood of the unrolled tape portion inadvertently returning onto the roll. It also does away with, the prior art requirement of necessarily using the cutting surface as a surface against which the tape automatically rests. And it allows the operator to intuitively grasp the dispenser.

Overall the tape dispenser is of lower material cost and simpler to manufacture than the prior art dispensers. In its most basic form the tape dispenser may be manufactured from a one-piece moulding.

A further overall advantage of this configuration is that the underside of the dispenser within the core of the roll is so shaped to match the cupped profile of the operator's palm.

### BRIEF DESCRIPTION OF THE DRAWINGS

FIG. 1 shows a front perspective view according to the invention.

FIG. 2 shows a left side view according to the invention.

FIG. 3 shows a back perspective view according to the invention.

FIG. 4 shows a right side view according to the present invention showing two possible constructions.

FIGS. 5a, 5b, 5c and 5d show a top view, back view, front view and bottom view respectively according to the present invention.

FIG. 6 shows an in use back perspective view according to the present invention.

FIGS. 7a to 7g show embodiments of the profile of the tape-cutting means according to the present invention.

FIG. 8 shows a side view of a further embodiment of the invention.

FIGS. 9a and 9b show a back view and a side view of a further embodiment of the invention.

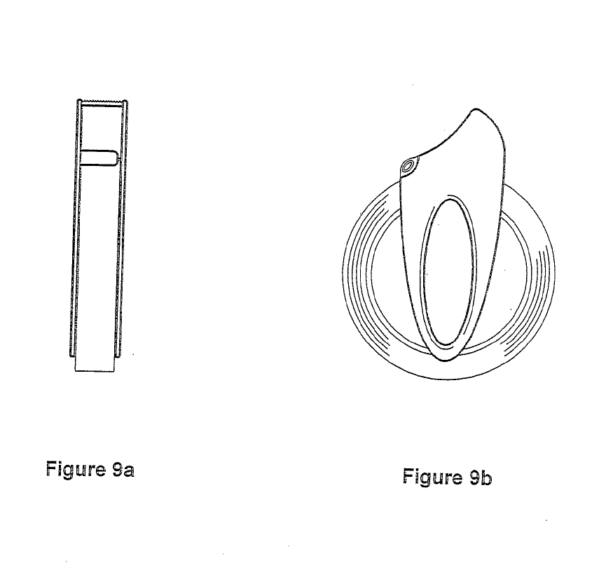

### DETAILED DESCRIPTION OF THE INVENTION

The figures present different views and aspects of a tape dispenser generally referenced 10 which will now be described in more detail.

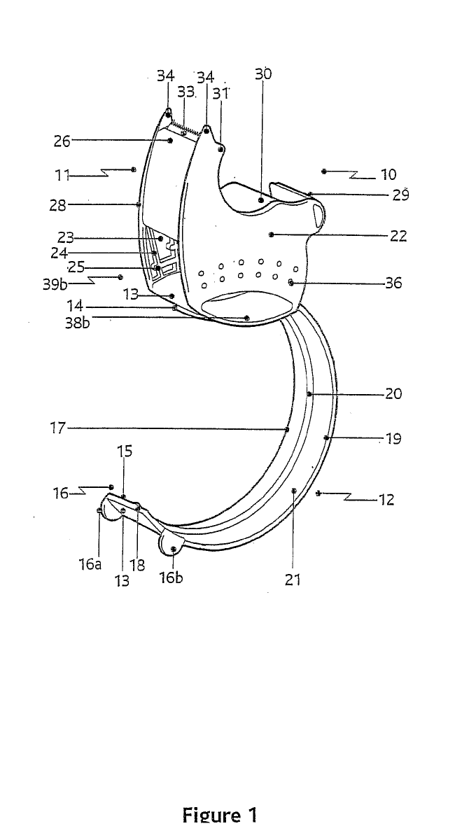

Initially looking at FIG. 1, a tape dispenser 10 comprising a main body portion 11 and a curved inner surface engaging portion 12 being so shaped as to permit the upper surface 13 to substantially engage with the inner surface of the reel to be dispensed is shown. A first or proximal end 14 of the curved inner surface engaging portion 12 is attached to the main body portion 11 and a second or distal end 15 includes side engaging tabs 16 being substantially perpendicular to the distal end 15 of the inner engaging portion 12 to engage with the side surfaces of the reel to be dispensed, in use and, as the curved inner surface portion 12 freely rotates within the roll to be dispensed, side engaging tabs 16 maintain the position of the inner surface engaging portion 12 therein. A first tab 16a of the side engaging tabs 16 is connected to the inner surface engaging portion 12 along a side edge 17 in line with the front edge 18 of the distal end 15 of the inner surface engaging portion 12 and a second tab 16b is connected to the inner surface engaging portion 12 along an opposing side edge 19, substantially parallel to the first tab 16a and displaced from the front edge 18. The curved inner surface engaging portion 12 is substantially flexible to allow positioning within the variety of differing diameter reels and substantially resilient in nature, so as to return to the original shape when no longer in use. Rib 20 positioned on the lower surface 21 of the inner surface engaging portion 12, strengthens the inner surface engaging portion 12 and assists the resilience.

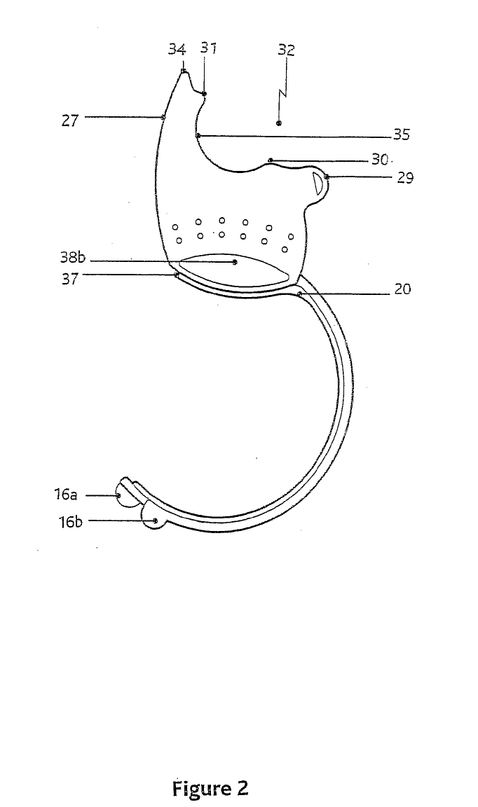

The main body portion 11 has a first side panel 22 that abuts the inner surface engaging portion 12 about its side edge 19 and a second side panel 23 which abuts along the opposing side edge 17. Upon the inner surfaces of side panels 22, 23 are vertical ribs 24 which strengthen the panel and horizontally curved ribs 25, which strengthen the panel and project outwardly towards the opposing panel. A forward panel 26 joins the two side panels 22, 23 along their upper forward edge 27, 28. Three transversal projections, 29, 30, 31 are mounted about the side panel 22 along its upper edge 32 (see FIG. 2). The first projection 29 provides a tape guide and a thumb rest, the second projection 30 shown mounted between the side panels 22, 23 provide the first contact/retention surface as the roll is unwound. The third projection 31 provides a second contact/retention surface for the unwound tape.

The two contact/retention surfaces 30, 31 illustrated are multi-purpose, they can be used by the user to pick up the tape and as a resting place for the tape to reduce the likelihood of losing the tape end once the dispenser 10 is loaded and in use. Two such surfaces 30, 31 are shown but of course more may be utilised.

The main body portion 11 is not limited to being a multi-part device, it may be formed as a one-piece device suitable for either left-handed or right-handed grasping operation and recognisable as such from the location of the first projection/tape guide/ thumb rest 29. Such a configuration does not require the attachable/detachable second side panel 23—the combination of the user's hand and the side engaging tabs 16a, 16b are sufficient to retain the tape reel in position whilst the tape is being dispensed. An additional side engaging tab or tabs may be introduced with this configuration located towards the upper region of the curved inner engaging portion 12 and substantially adjacent the main body portion 11.

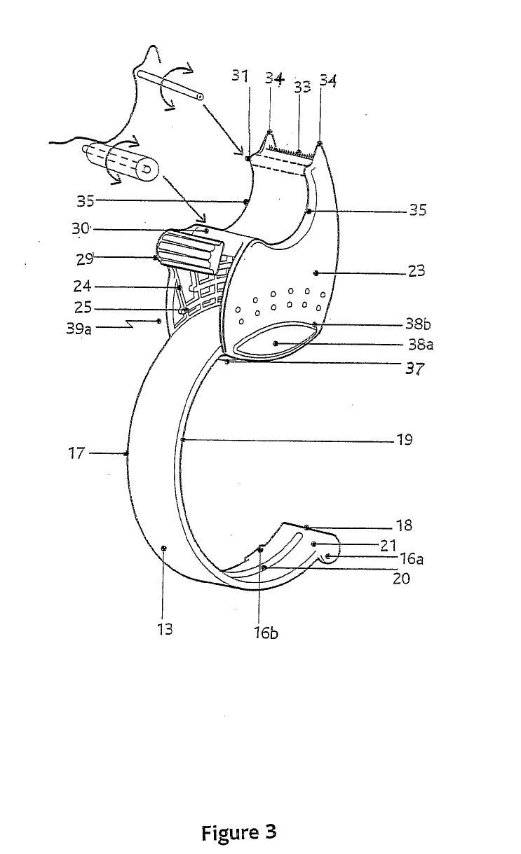

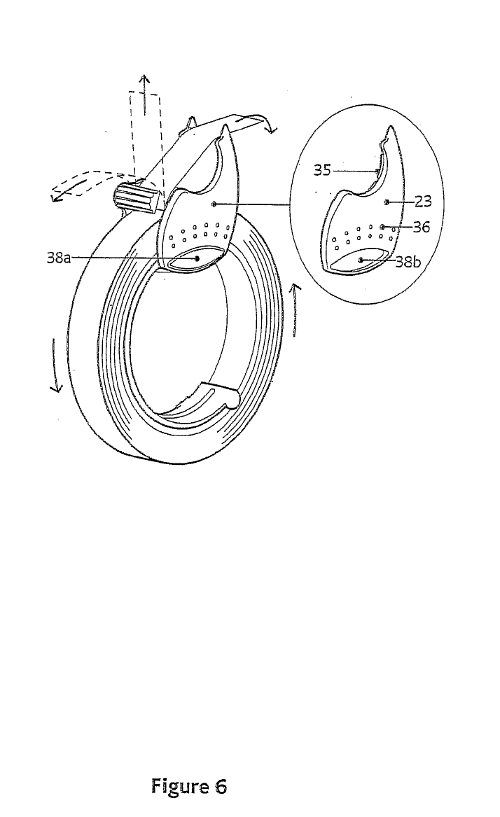

It can be seen more clearly in FIG. 3 that the tape guide/thumb rest 29 is elevated and includes surface detail to resist slipping. This thumb rest 29 provides an inbuilt dispensing action to the user; it provides an opening through which the tape can be drawn out of the dispenser when lifted off of the reel, a purchase point against which the tape can be pulled against by the user during operation thereby reducing the effort required by the user and to a certain extent, a brake (see FIG. 6). The first contact/retention surface 30 is forward of the tape guide/thumb rest 29 and the second contact/retention surface 31 is positioned forward of the previous two projections 29, 30 and elevated above them. Tape guide/thumb rest 29 can be mounted on either side of the tape dispenser 10. The device is usable both with left- or right-handed operation requiring only a change of orientation during use.

A cutting surface 33 (see FIG. 1) is recessively mounted between the highest points 34 of the side panels 22, 23 which act as side guards to the cutting surface 33. At least one of the side panels 22, 23 has been cut away 35 between the first and second contact/retention surfaces 30, 31 to provide the operator with access to the tape between successive cuts. Outwardly projecting dimples 36 are provided on either outer surface of the side panels 22, 23 to assist lifting the tape dispenser 10.

When initially unwinding the tape from the reel the non-adhesive side of the tape may come into contact with the underside/upper surface of the tape guide/thumb rest 29 so as to retain the tension in the extended tape portion before coming into contact with the first and second contact/retention surfaces 30, 31 and the cutting surface 33. The tape guide/thumb rest 29 also provides a surface to bear against to assist unrolling the tape.

The first contact/retention surface 30 and the second contact/retention surface 31 may be fixably mounted, but advantageously these may be rotatably mounted. The surface finish of the first and second contact/retention surfaces 30, 31 is such to assist both the retention and the easy release of the adhesive side of the tape without eliminating the adhesive effect. The underside 37 of the main body portion 11 is curved to match the operator's palm when lifting the tape dispenser 10 for use and provides a rest for the operators' fingers in use. An outwardly projecting panel 38a bounded by the underside 37 of the main body portion 11 and the upper surface 13 of the inner surface engaging portion 12 is provided. Panel 38a may be either transparent, multicoloured or provide an area where advertising material such as, for example, brand names, can be displayed. This panel 38a connects to the side panel 23 at recess 38b within the side panel 23 which is so shaped to mate with the panel 38a. Panel 38a and recess 38b may mate either slidably, hinged or by push fit means. Whilst panel 38a is illustrated in the right side panel 23 it may be a feature of either or both sides 22, 23 of the dispenser 10

In use, as shown in FIG. 6, the tape roll is mounted within channel 39. The entrance 39a of channel 39 is bounded by the side panels 22, 23, the upper surface 13 of the inner surface engaging portion 12 and the thumb rest 29 and the channel exit 39b is bounded by the front edge 18 of the upper surface 13 of the inner surface engaging portion 12, the side is panels 22, 23 and the forward panel 26.

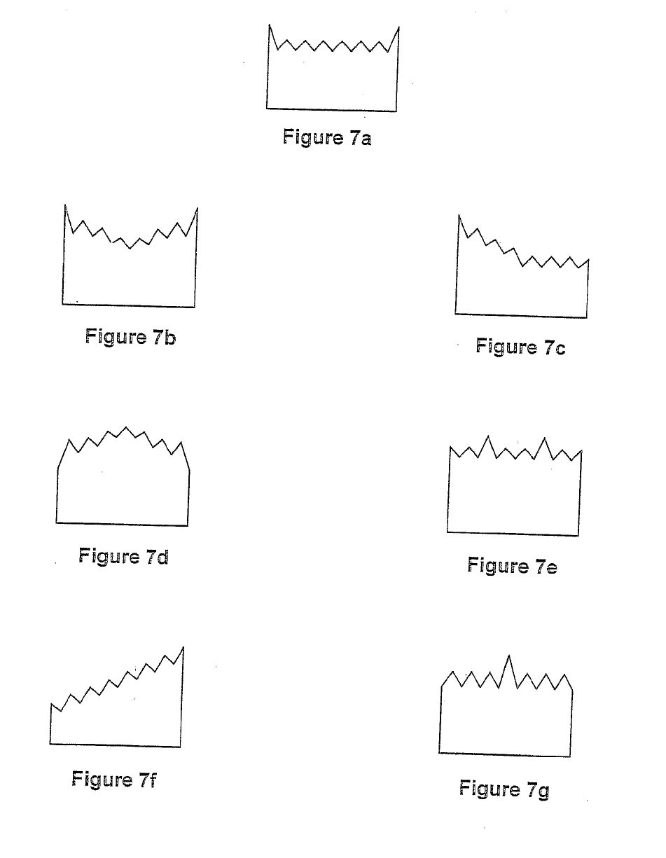

FIG. 7 shows examples of blade profile. The profile of the teeth may be such that the material will be restrained by the teeth after the cutting action has been performed.

In use the dispenser 10 maintains a fixed position whilst the tape reel being dispensed rotates and diminishes in size as the tape is severed from the reel. The operator grasping the device effectively provides an axle for the core of the tape reel to rotate around.

After use the free end of the tape is retained under tension away for the tape reel preventing any unassisted motion of the tape reel and ready for further use.

A variety of different sizes of tape reel cores and tape widths and/or tape depths can be used with the dispenser 10.

The shape of the tape dispenser 10 provides an inherent springyness assisting the operator when extending the tape towards him or her against the tape guide/thumb rest 29 and further assisting the operator when cutting the tape by reducing the force required to make the cut against the blade 33.

The tape dispenser 10 is described as having a mobile, hand-held, two-handed operation but with the addition of sufficient mounting fixtures may also be surface mounted whether, for example, on a desk, against a wall or the like requiring only one hand to operate. This is of particular importance to operators having limited mobility and/or manual dexterity.

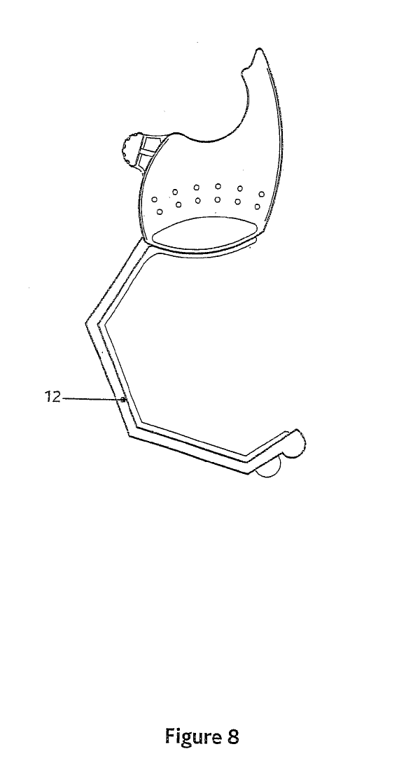

Throughout this description the term arc is to be interpreted broadly and may for example cover an arc of the kind shown in FIG. 8.

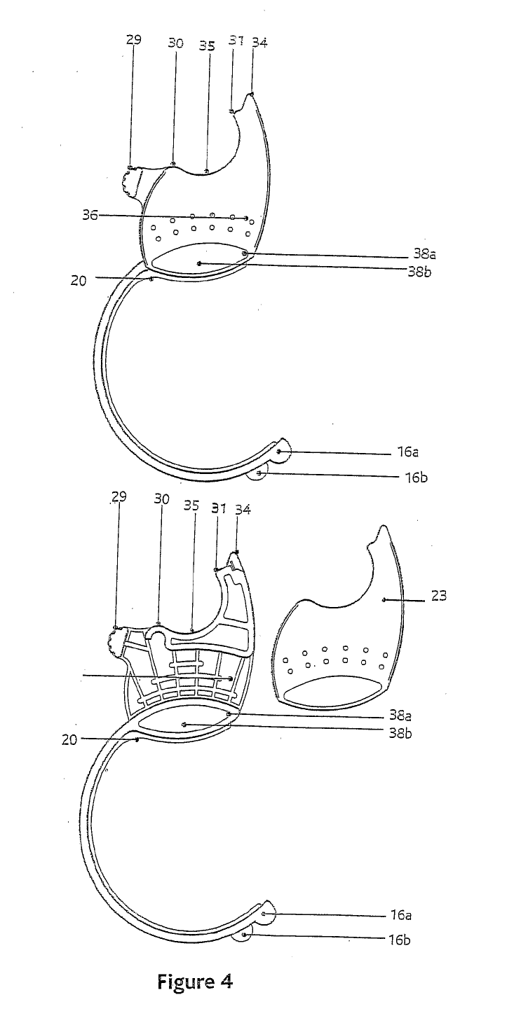

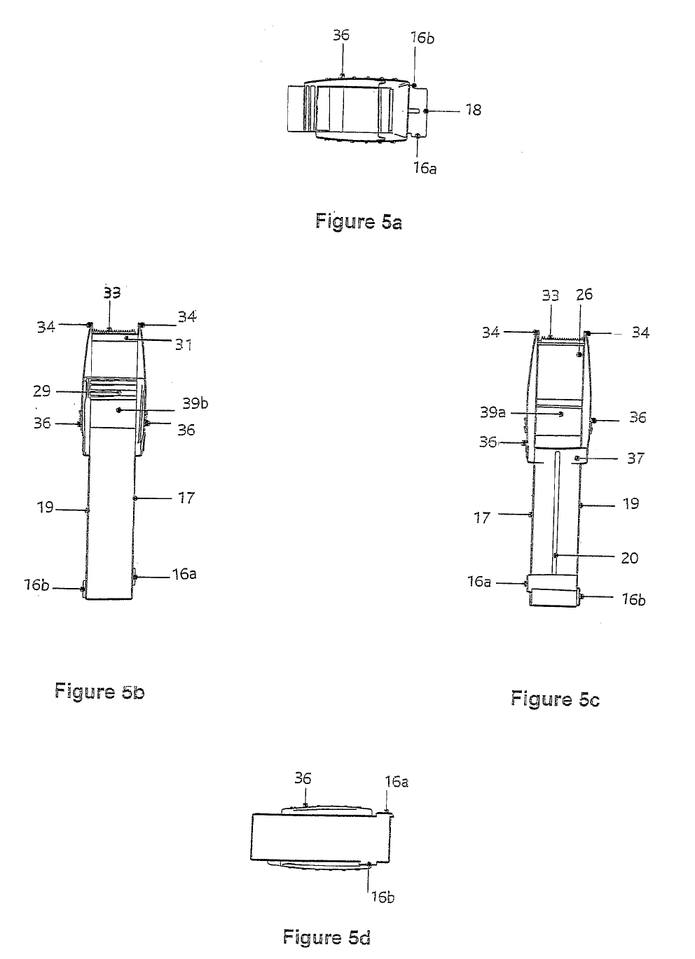

To mount a roll within the tape dispenser 10 shown in FIGS. 1 to 6, and 8 the operator must first detach the side panel 23 in which panel 38a is located. Once the detachable side panel 23 is so removed, the tape reel can be slotted within the channel 39 below the tape guide/thumb rest 29, the first contact surface 30 and above the upper surface 13 of the inner surface engaging portion 12. Once so positioned, the detachable side panel 23 is replaced. With regard to the detachable side panel 23, it may be releasably attached to the main body portion 11 of the tape dispenser 10 by a variety of means, for example, sliding, push-fit means, hinge mechanisms or any combination therebetween. It should be noted that the detachable side panel 23 is optional and the device functions without it. If the detachable side panel 23 is not used a further side engaging tab along the side of the inner surface engaging portion 12 in the upper region adjacent the main body portion 11 may also be provided but again this is optional.

The tape reel is correctly positioned when the free end is at the channel entrance 39a, the operator lifts the free end of the tape guiding the tape beneath the tape guide/thumb rest 29, and then extends the tape upwardly and rearwardly towards the operator against the tape guide/thumb rest 29, until sufficient tape has been extended then in a forward motion over the first contact/retention surface 30, the second contact/retention surface 31 and between the upper most part 34 of the side panels 22, 23 above the blade 33. A downward action pulling the tape over the recessed blade 33 will cut the tape. The uncut section of the tape will then be maintained in position against the first contact/retention surface 30 and the second contact/retention surface 31.

To unwind further tape, the user grabs the device in one hand and with the other hand grasps the tape above the or each cut away section 35 within the side panels 22, 23 between the first and second contact/retention surfaces 30, 31. The user lifts the tape repeating the action described above or else in an upwardly direction until sufficient material has been unwound and the cut is achieved by drawing the tape over the blade 33 in a downward direction.

1-12. (canceled)

13. A tape dispenser in which a component for securing the dispenser to a tape roll comprises an arc forming an open collar which conforms with the hollow core; of sufficient length to fit within the hollow core of the roll; and follows a section of the hollow core's circumference in order to hold the dispenser on the roll whilst allowing the roll to rotate relative to the dispenser as the tape unrolls in use; holders for holding the unrolled portion of the tape away from the roll; and a cutter for cutting the tape from the unrolled portion; wherein the holders for holding the unrolled portion of tape away from the roll consists of respective first and second spars on the dispenser spanning or substantially spanning the tape width and a withdrawn portion having at least one side opening between the first and second spars; whereby said portion forms a space which is sufficient to allow a user of the dispenser to insert a finger from the side of the tape and lift the tape from the spars.

14. A tape dispenser according to claim 13, wherein the tape-cutter includes teeth of at least two different tooth profiles.

15. A tape dispenser according to claim 13, wherein the tape-cutter is guarded at at least one tape-edge region by means tending to prevent the tape being pulled off its centre line as the tape is severed.

16. A tape dispenser according to claim 13, wherein at least one of the first and second spars can be rotated by the tape as the tape is unrolled.

17. A tape dispenser according to claim 13, further comprising a third spar, spanning or substantially spanning the tape width, in use, above the unrolled portion of the tape and so positioned that a user can rest a portion of their hand against it without hindering the tape movement.

18. A tape dispenser according to claim 17, wherein a side opening is provided beneath said third spar.

19. A tape dispenser according to claim 13, wherein a portion of the core supporting arc adjacent the main body of the dispenser is curved in the opposite sense to the curve of the rest of the arc.
